(19) United States
(12) Patent Application Publication
(10) Pub. No.: US 2018/0309141 A1
(43) Pub. Date: Oct. 25, 2018

(54) METALLIC MEMBER USED FOR FUEL CELL STACK

(71) Applicant: TOYOTA JIDOSHA KABUSHIKI KAISHA, Toyota-shi (JP)

(72) Inventors: Yuhei ASANO, Toyota-shi (JP); Hiroshi YANAGIMOTO, Miyoshi-shi (JP)

(21) Appl. No.: 15/934,211

(22) Filed: Mar. 23, 2018

(30) Foreign Application Priority Data
Apr. 21, 2017 (JP) 2017-084291

(51) Int. Cl. H01M 8/0202; B32B 15/04; B32B 33/00; H01M 8/0206; H01M 8/0215; H01M 8/0228; H01M 8/0258; H01M 8/22

(52) U.S. Cl. CPC H01M 8/0269; B32B 15/04; B32B 33/00; H01M 8/0206; H01M 8/0215; H01M 8/0228; B32B 2457/18; H01M 8/22; B32B 2250/03; B32B 2250/40; B32B 2264/108; B32B 2313/04; H01M 8/0258

(57) ABSTRACT

A metallic conducting function member used for conducting electricity in a fuel cell stack comprises a conductive inorganic film on a surface of a metal base material. The inorganic film that is a thin film made of a conductive inorganic material includes a carbon-based conductive material dispersed at a weight ratio that is equal to or higher than 20%. Using this metallic conducting function member for a stack of fuel cells that is a stack of power generation cells each obtained by sandwiching an electrolyte membrane having proton conductivity with an anode electrode and a cathode electrode can lead to small contact resistance value and high corrosion resistance.

### CROSS-REFERENCE TO RELATED APPLICATION

The present application claims priority from Japanese application P2017-084291 filed on Apr. 21, 2017, the content of which is hereby incorporated by reference into this application.

### BACKGROUND

### 1. Field

This specification discloses a metallic member used for a fuel cell stack.

### 2. Related Art

Fuel cells include a stack of a plurality of power generation cells each obtained by sandwiching an electrolyte membrane having proton conductivity with an anode electrode and a cathode electrode. Each of the power generation cell is provided with a separator that separates the power generation cell from an adjacent power generation cell and a flow path plate forming a gas flow path. The separator and the flow path plate need to enable electricity, generated by the power generation cells, to pass therethrough, and are referred to as metallic conducting function members in some cases. The metallic conducting function member is made of a base material formed of metal (hereinafter, referred to as a metal base material) so that strength and conductivity can be ensured. Such a metallic conducting function member is further required to have high corrosion resistance. In this context, for example, JP-A-2007-266014 proposes a separator formed with an outer surface of a metal base material covered with a resin film including a conductive material to have conductivity.

The resin film of this separator disclosed in JP-A-2007-266014 includes resin with no conductivity. Thus, the conductivity of the resin film depends on a status of the conductive material included in the resin film. For example, a conducting path might be insufficiently established due to insufficient contact between conductive materials. In such a case, conductivity of the separator as a whole might be compromised because the resin lacks conductivity and thus cannot compensate for the lack of conductivity in the insufficient contact portion in the conducting path. The same applied to a metal flow path plate having a gas flow path formed and providing a conducting function as in the case of the separator. All things considered, conductivity of a metallic conducting function member having a surface provided with a cover layer is required to be ensured.

### SUMMARY

The present specification discloses the following aspects.

(1) According to an aspect of the present disclosure, a metallic conducting function member used for a fuel cell stack is provided. The metallic conducting function member used for a fuel cell stack is used for conducting electricity in the fuel cell stack. The metallic conducting function member comprises a conductive metal base material, and an inorganic film that covers a surface of the metal base material. The inorganic film is a thin film made of a conductive inorganic material, and includes a carbon-based conductive material dispersed at a weight ratio concentration that is equal to or higher than 20%.

With the metallic conducting function member used for a fuel cell stack according to this function, a weight ratio concentration of a carbon-based conductive materials, dispersed and included in the film, is appropriately adjusted. Thus, a sufficiently low contact resistance value of the metallic conducting function member can be achieved. This is based on an idea that a sufficient conducting path is ensured in an inorganic film through contact between the carbon-based conductive materials. Furthermore, the inorganic film in which the carbon-based conductive materials are dispersed and included is conductive in a first place. Thus, the conductivity of the metallic conducting function member can be more effectively ensured.

(2) In the above-described aspect, the inorganic film covering the surface of the metal base material may have a thickness that is equal to or larger than 50 nm. With this aspect, anticorrosion performance on the surface of the metal base material can be more effectively achieved, with the thickness of the inorganic film appropriately adjusted.

(3) In the above-described aspect, the inorganic film may be a crystalline thin film made of the inorganic material. With this aspect, most of gaps in the inorganic film can be made smaller than molecules of corrosive liquid, whereby erosion due to the corrosive liquid can be suppressed.

(4) In any one of the above-described aspects, the weight ratio of the carbon-based conductive material in the inorganic film may be equal to or lower than 50%. With this aspect, the amount of the carbon-based conductive materials used can be limited, whereby a material cost can be reduced. Furthermore, establishing of the conducting path, through contact between the carbon-based conductive materials, can be more effectively ensured.

(5) In any one of the above-described aspects, the inorganic film covering the surface of the metal base material may have a thickness that is equal to or smaller than 500 nm. With this aspect, the amount of the inorganic material used can be limited, whereby the material cost can be reduced.

The technique according to the present disclosure can be implemented with various aspects. For example, the technique can be implemented as a method for manufacturing a metallic conducting function member for a fuel cell and as a fuel cell.

With the disclosed technique, a conducting path between the surface of a metal base material and the metal base material in an inorganic film can be easily formed.

### BRIEF DESCRIPTION OF THE DRAWINGS

FIG. 1 is a schematic perspective view illustrating a configuration of a fuel cell employing an embodiment;

FIG. 2 is a partial cross-sectional view of unit cells taken along line 2-2 in FIG. 1;

FIG. 3 is an enlarged schematic view of a portion of a separator illustrated in FIG. 2, illustrating a cover layer on a surface of the separator;

FIG. 4 is a diagram illustrating comparison, in an initial contact resistance value and a post-anticorrosion-test resultant resistance value, among evaluated titanium plates that have the same layer thickness of a cover layer but are different from each other in a CNT dispersed amount;

FIG. 5 is a diagram illustrating comparison, in the initial contact resistance value and the anticorrosion test result, among comparative titanium plates that have the same layer thickness of a resin cover layer but are different from each other in the CNT dispersed amount; and

FIG. 6 is a diagram illustrating comparison, in the initial contact resistance value and the post-anticorrosion-test resultant resistance value, among evaluated titanium plates that have the same CNT dispersed amount but are different from each other in the layer thickness of the cover layer.

### DESCRIPTION OF THE PREFERRED EMBODIMENTS

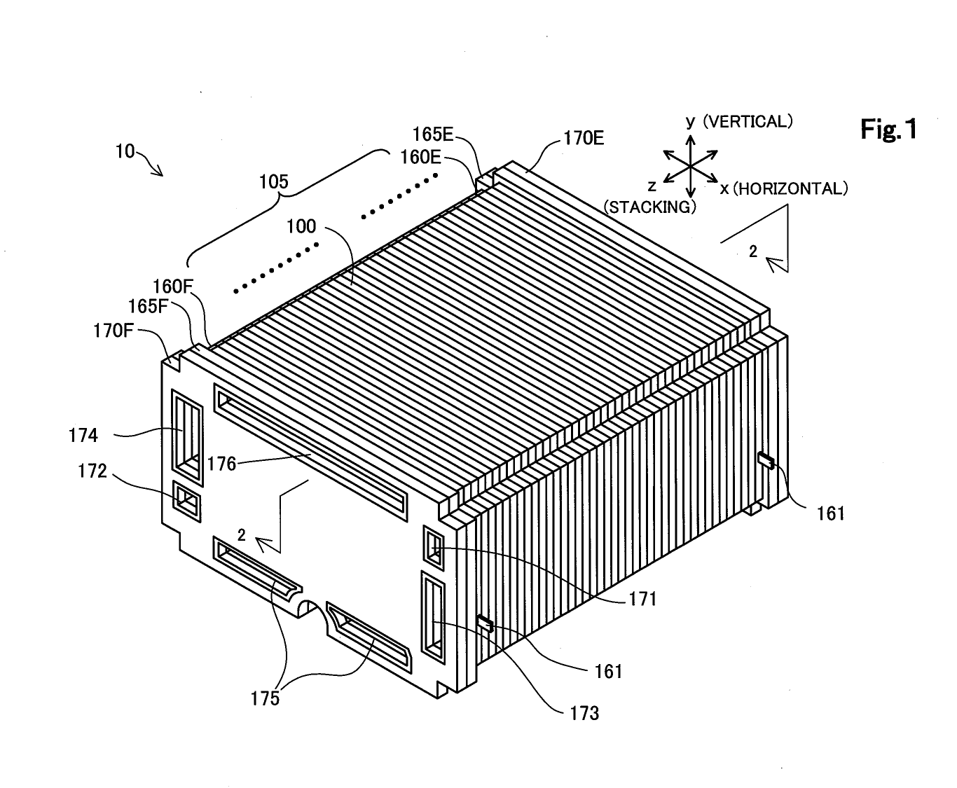

FIG. 1 is a schematic perspective view illustrating a configuration of a fuel cell 10 employing the present embodiment. The fuel cell 10 is formed with a fuel cell stack 105 sandwiched by a pair of end plates 170E and 170F. The fuel cell stack 105 includes a plurality of unit cells 100 stacked in a Z direction (hereinafter, also referred to as a “cell stacking direction”). The fuel cell 10 has an insulating plate 165F interposed between the end plate 170F on one end side and the fuel cell stack 105, and has a terminal plate 160F provided on this side. The one end side of the fuel cell 10 provided with the end plate 170F is referred to as a front end side and the other end side, which can be regarded as a farther side in the figure, is referred to as a rear end side for the sake of description.

Similarly, the fuel cell 10 has an insulating plate 165E on the rear side interposed between the end plate 170E on the rear end side and the fuel cell stack 105, and has a terminal plate 160E on the rear end side. Each of the unit cells 100 of the fuel cell stack 105, the terminal plates 160E and 160F, the insulating plates 165E and 165F, and the end plates 170E and 170F has a plate structure with a substantially rectangular outer shape. The fuel cell 10 is arranged to have a direction of the long sides defined as an X direction (horizontal direction) and a direction of the short sides defined as a Y direction (perpendicular direction, vertical direction).

The terminal plate 160F and the terminal plate 160E respectively on the front and the rear end sides are metal plates for outputting power generated in the fuel cell stack 105. Power generated by each of the unit cells 100 is collected through the separator, serving as a metallic conducting function member according to the present embodiment, described later, and is output through current collector terminals 161 provided to the terminal plate 160F and the terminal plate 160E respectively provided on the front and the rear end sides. The insulating plate 165F and the insulating plate 165E, respectively on the front and the rear end side, ensure insulation between the terminal plates and the end plates described above. The end plate 170F and the end plate 170E respectively on the front and the rear end sides are each a light metal plate made of aluminum and the like, and thus are involved in supplying/discharging of gas and cooling water as described later.

The end plate 170F, the insulating plate 165F, and the terminal plate 160F on the front end side are each a plate with through holes including a fuel gas supply hole 171, a fuel gas discharge hole 172, an oxidant gas supply hole 173, an oxidant gas-discharge hole 174, cooling water supply holes 175, and a cooling water discharge hole 176. Specifically, the end plate 170F is provided on one end side (front end side) of the fuel cell stack 105, including the stacked unit cells 100, in the cell stacking direction. The end plate 170F includes through holes, such as the fuel gas supply hole 171, through which gas or a coolant (cooling water) is supplied and discharged to or from the fuel cell stack 105. The supply/discharge holes described above are each in communication with a corresponding one of holes (not shown) provided through the fuel cell stack 105 at a corresponding position, to form corresponding supply/discharge manifolds for gas or cooling water.

On the other hand, none of the end plate 170E, the insulating plate 165E, and the terminal plate 160E on the rear end side is provided with these supply/discharge holes. This is because of the configuration of the fuel cell 10 according to the present embodiment. Specifically, reaction gas (fuel gas or oxidant gas) and cooling water are supplied to the unit cells 100 from the endplate 170F on the front end side through the supply manifold. Discharge gas and discharge water from the unit cells 100 are discharged to the outside from the end plate 170F on the front end side through the discharge manifold. However, the configuration of the fuel cell is not limited to this. For example, the reaction gas and the cooling water may be supplied from the end plate 170F on the front end side, and the discharge gas and the discharge water may be discharged to the outside from the end plate 170E on the rear end side.

The oxidant gas supply hole 173 is formed to extend along the Y direction (short side direction) in an outer edge portion at a lower end of the end plate 170F on the front end side, and the oxidant gas discharge hole 174 is formed to extend along the X direction in an outer edge portion at an upper end. Left and right side in the X direction as relative to a direction toward the end plate 170F on the front end side are hereinafter respectively referred to as a “right side” and a “left side”. The fuel gas supply hole 171 is provided in a right outer edge portion of the end plate 170F on the front end side, at an upper end in the Y direction (short side direction). The fuel gas discharge hole 172 is provided in a left outer edge portion at a lower end in the Y direction. The cooling water supply hole 175 is arranged more on the lower side than the fuel gas supply hole 171 and extends along the X direction. The cooling water discharge hole 176 is arranged more on the upper side than the fuel gas discharge hole 172 and extends along the X direction. The supply/discharge holes described above, except for the fuel gas supply hole 171 and the fuel gas discharge hole 172, are each separated into a plurality of supply/discharge holes in each of the unit cells 100 of the fuel cell stack 105.

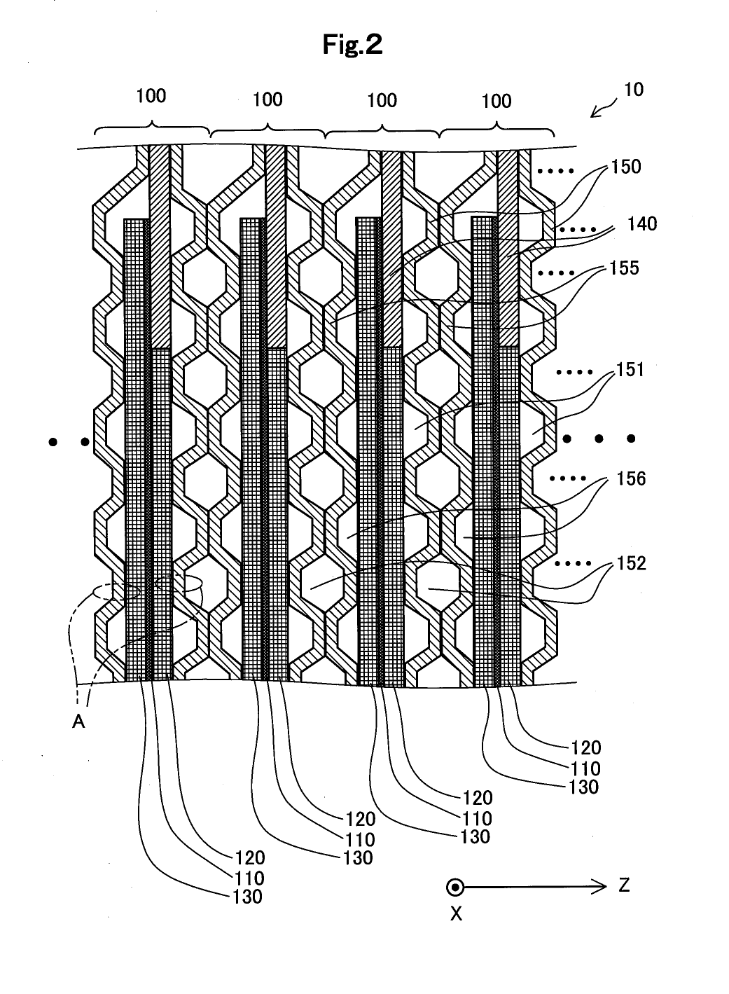

FIG. 2 is a schematic cross-sectional view of a part of the unit cell 100 taken along line 2-2 in FIG. 1. As illustrated in FIG. 2, the unit cell 100 includes catalyst layer joining electrolyte membranes 110 each sandwiched by a cathode side diffusion layer 120 and an anode side diffusion layer 130. The catalyst layer joining electrolyte membrane 110 and the anode side diffusion layer 130 are stacked in this order on the cathode side diffusion layer 120 attached to a frame 140. In the unit cell 100 with this configuration, the catalyst layer joining electrolyte membrane 110, sandwiched by the diffusion layers, are further sandwiched by a cathode side separator 150 and an anode side separator 155. The catalyst layer joining electrolyte membrane 110 is formed with an electrolyte membrane, having proton conductivity, sandwiched by both anode and cathode electrodes. The unit cell 100 including the catalyst layer joining electrolyte membrane 110 generates power through electrochemical reaction between hydrogen and oxygen supplied. The power thus generated is collected in a current collector terminal 161 in FIG. 1 through the separators 150 and 155 in contact with the anode side and the cathode side diffusion layers. Thus, both separators described above serve as metallic conducting function members, for fuel cell, providing a conducting function in the unit cell 100 serving as a power generation cell.

The separators 150 and 155 are members formed by press molding, and are formed with metal base material surfaces with unevenness covered with cover layers 200 described later. One separator 150 has unevenness so that a plurality of oxygen flow paths 151 are formed between the separator 150 and the cathode side diffusion layer 120. The oxygen flow paths 151 guide oxidant gas from the oxidant gas supply hole 173 of each of the unit cells 100 to the cathode side diffusion layer 120, and enable extra oxidant gas to be discharged to the oxidant gas discharge hole 174. The other separator 155 has unevenness so that a plurality of hydrogen flow paths 156 are formed between the separator 155 and the anode side diffusion layer 130. The hydrogen flow paths 156 guide fuel gas from the fuel gas supply hole 171 of each of the unit cells 100 to the anode side diffusion layer 130, and enable extra fuel gas to be discharged to the fuel gas discharge hole 172. The separators 150 and 155 for adjacent unit cells 100 are in contact with each other, whereby coolant flow paths 152 are formed between the separators. The coolant flow paths 152 guide the coolant from the cooling water supply holes 175 of the unit cells 100 so that the coolant is guided to the cooling water discharge hole 176. The anode side separator 155 extends to the frame 140 at the circumference edge of the anode side diffusion layer 130, and is airtightly bonded to the frame 140. Specifically, the separator 155 is bonded to the frame 140 in an area surrounding the anode side diffusion layer 130 and is press molded to have a large unevenness in this surrounding area.

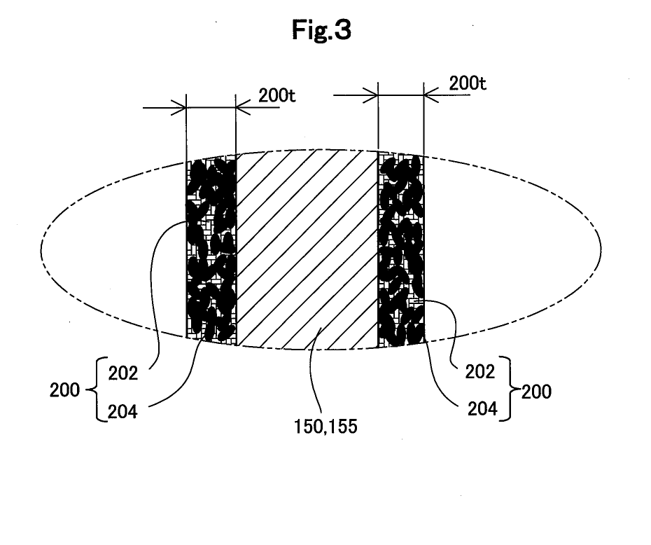

The metal base material used for the separators 150 and 155 may be any highly conductive material including stainless steel, titanium, titanium alloy, aluminum, and aluminum alloy. In the present embodiment, titanium is employed for example, and thus the cover layer 200 is formed on a surface of a titanium base material. FIG. 3 is an enlarged schematic view of a portion A of the separator illustrated in FIG. 2, illustrating the cover layer 200 on the surface of the separator. Note that FIG. 3 is a schematic view and thus does not reflect the thicknesses of an actual base material and an actual layer thickness.

The cover layers 200 are formed on front and back surfaces of the metal base material used for the separators 150 and 155. Specifically, carbon nanotubes 204 (hereinafter, referred to as CNTs 204) that are a carbon-based conductive material are dispersed and included in an inorganic film 202 that is a thin film made of a conductive inorganic material such as indium tin oxide (ITO) and antimony trioxide (ATO).

Next, a process of forming the cover layers 200 on the separators 150 and 155 according to the present embodiment is described. The cover layer 200 is formed through first to third processes. In the first process, a film stock solution is prepared. In the subsequent second process, the CNTs 204 are dispersed into the film stock solution. Then, in the final third process, the cover layer 200 including the inorganic film 202 is formed on the metal base material surface. In the first process of the present embodiment, 0.1 mol/L of stannic chloride (SnCl₂) and 0.01 mol/L of antimony chloride (SbCl₃) are mixed into an ethanol solution, and the resultant solution is stirred for 24 hours. The ethanol solution as a result of the stirring is obtained as the film stock solution.

In the second process of the present embodiment, the CNTs 204 are mixed into the film stock solution, obtained by mixing the stannic chloride and the antimony chloride and stirring the resultant solution, to achieve a dispersed CNT target concentration (20 to 50 wt %). With the CNTs thus mixed and the resultant solution stirred, the film stock solution includes the CNTs 204 dispersed therein. The solution is prepared in such a manner that the CNTs 204 each have a diameter of 0.4 to 50 nm and a length of 100 nm to 10 μm. Evaluation for the dispersed CNT target concentration (20 to 50 wt %) will be described later.

In the third process of the present embodiment, film forming is performed as follows. First of all, the titanium base materials molded to have unevenness, serving as original plates of the separators 150 and 155 which are film forming targets, are heated at 500° C. in a heating furnace. Meanwhile, the film stock solution is irradiated with ultrasonic waves with a wavelength of 2.4 MPa, so that mist with particle size of approximately 1 to 5 μm is generated. This mist from the film stock solution is mixed in carrier gas (argon gas for example). The resultant gas is continuously sprayed onto the front and the back surfaces of the titanium base material that has been heated up to 500° C., for 20 minutes. The film stock solution that has been sprayed receives heat from the titanium base material that has been heated up to 500° C., to have solution components evaporated. As a result, the inorganic film 202 is formed on the surfaces of the titanium base material. The inorganic film 202 is formed in a high temperature environment of 500° C., and thus is formed as a crystalline thin film of tin and antimony that are inorganic materials in the film stock solution These processes yield the separators 150 and 155 each having the front and the back surfaces provided with the cover layers 200 with the inorganic film 202 having the CNTs 204 dispersed and included at the dispersed CNT target concentration.

Next, performance evaluation for the separators 150 and 155 thus obtained is described. Samples used in the evaluation test are referred to as evaluated titanium plates. The evaluated titanium plates each include the cover layers 200 formed on the front and the back surfaces of the titanium base material having a flat plate shape and the same thickness as the separators. The dispersed amount of the CNTs 204 in the cover layer 200 (CNT wt %) and the thickness of the cover layer 200 (layer thickness 200t: see FIG. 3) are correlated. Considering this, the following evaluated titanium plates were prepared for the separator performance evaluation.

Evaluated first titanium plate HP1: CNT wt %: 0 (no CNT dispersed)/layer thickness 200t: 50 nm;

Evaluated second titanium plate HP2: CNT wt %: 5/layer thickness 200t: 50 nm;

Evaluated third titanium plate HP3: CNT wt %: 10/layer thickness 200t: 50 nm;

Evaluated fourth titanium plate HP4: CNT wt %: 20/layer thickness 200t: 50 nm;

Evaluated fifth titanium plate HP5: CNT wt %: 30/layer thickness 200t: 50 nm;

Evaluated sixth titanium plate HP6: CNT wt %: 40/layer thickness 200t: 50 nm;

Evaluated seventh titanium plate HP7: CNT wt %: 50/layer thickness 200t: 50 nm;

Evaluated eighth titanium plate HP8: CNT wt %: 50/layer thickness 200t: 10 nm;

Evaluated ninth titanium plate HP9: CNT wt %: 50/layer thickness 200t: 30 nm.

The evaluated first titanium plate HP1 to the evaluated seventh titanium plate HP7 each have the cover layer 200 with the layer thickness 200t of 50 nm, and are different from each other in the dispersed amount of the CNTs 204 (CNT wt %). The evaluated seventh titanium plate HP7 to the evaluated ninth titanium plate HP9 each have the dispersed amount of the CNTs 204 (CNT wt %) that is 50 wt % and are different from each other in the layer thickness 200t of the cover layer 200.

The following comparative titanium plates are prepared to be compared with the evaluated titanium plates. The comparative titanium plates each have a resin cover layer with a layer thickness of 1 μm, instead of the cover layer 200 including the inorganic film 202. The CNTs 204 are dispersed and included in the resin cover layer.

Comparative first titanium plate TP1: CNT wt %: 5/layer thickness 200t: 1 μm;

Comparative second titanium plate TP2: CNT wt %: 10/layer thickness 200t: 1 μm;

Comparative third titanium plate TP3: CNT wt %: 20/layer thickness 200t: 1 μm;

Comparative fourth titanium plate TP4: CNT wt %: 30/layer thickness 200t: 1 μm;

Comparative fifth titanium plate TP5: CNT wt %: 40/layer thickness 200t: 1 μm;

Comparative sixth titanium plate TP6: CNT wt %: 50/layer thickness 200t: 1 μm.

The comparative first titanium plate TP1 to the comparative sixth titanium plate TP6 each have the resin cover layer with the layer thickness 200t of 1 μm, and are different from each other in the dispersed amount of the CNTs 204 (CNT wt %).

Conductivity evaluation and corrosion resistance evaluation are performed as the performance evaluation. In the conductivity evaluation, a contact resistance value of the evaluated first titanium plate HP1 to the evaluated ninth titanium plate HP9 and the comparative first titanium plate TP1 to the comparative sixth titanium plate TP6 was measured. Specifically, the resistance value was measured under the following condition. A gold-plated copper plate is laid over the film surface of the cover layer 200 of each of the evaluated first titanium plate HP1 to the evaluated ninth titanium plate HP9 with carbon paper (TGP-H-120 manufactured by Toray Industries, Inc.) interposed therebetween. The copper plate and each of the evaluated titanium plate were pressed to each other with pressure of 0.98 MPa per unit area. This pressing state was maintained with a jig. A voltage value as a result of applying constant current between each of the evaluated titanium plate and the copper plate in the pressed state was measured, and contact resistance based on a current value and the measured voltage value was obtained as an initial contact resistance value. The contact resistance value was obtained for each of the comparative first titanium plate TP1 to the comparative sixth titanium plate TP6 through a similar manner. The carbon paper for each of the comparative first titanium plate TP1 to the comparative sixth titanium plate TP6 was in contact with the film surface of the resin cover layer used instead of the cover layer 200 including the inorganic film 202.

The corrosion resistance evaluation was performed under a condition replicating a strongly acid environment that may be established while the fuel cell 10 is operating. First of all, each of the evaluated first titanium plate HP1 to the evaluated ninth titanium plate HP9 and the comparative first titanium plate TP1 to the comparative sixth titanium plate TP6, maintained in the pressed state by the jig, was immersed in strongly acid corrosive liquid. Then, rated voltage of 0.9 V was applied between the copper plate and the titanium plate in the immersed state. Then, the contact resistance was obtained after a predetermined period of time has elapsed, as the post-anticorrosion-test resultant resistance value. The highly acid corrosive liquid used was pH3 highly acid solution including fluorine (F) and chlorine (Cl).

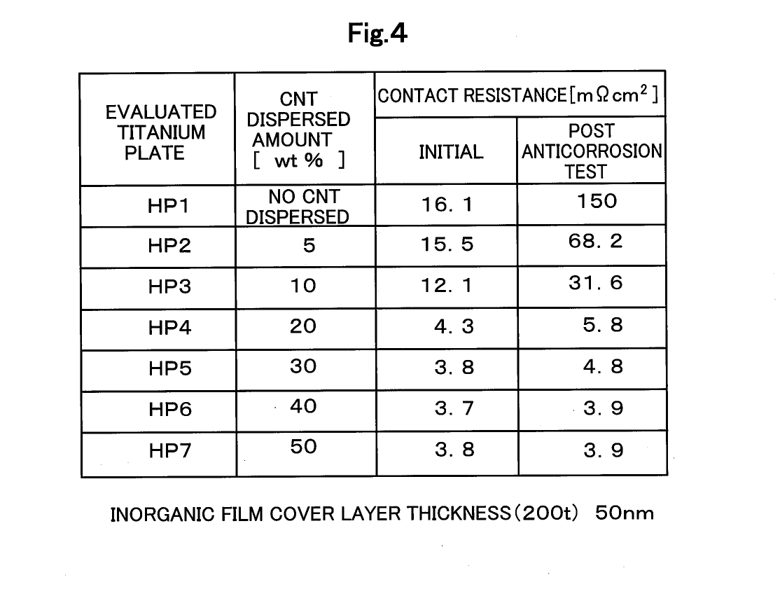

FIG. 4 is a diagram illustrating comparison, in the initial contact resistance value and the post-anticorrosion-test resultant resistance value, among the evaluated titanium plates that have the same layer thickness 200t of the cover layer 200 but are different from each other in the CNT dispersed amount.

The comparison in the resistance value illustrated in FIG. 4 clearly indicates that a larger dispersion amount of the CNTs 204 in the cover layer 200 including the inorganic film 202 leads to a lower initial resistance value and a lower post-anticorrosion-test resultant resistance value. The dispersion amount of the CNTs 204 within a range between 20 and 50 wt % results in only a slight increase in the post-anticorrosion-test resultant resistance value from the initial contact resistance value, and thus is found to be practically useful. This ensures the conductivity of each of the separators 150 and 155 according to the present embodiment having the surfaces provided with the cover layers 200 including the inorganic film 202, including the evaluated fourth titanium plate HP4 to the evaluated seventh titanium plate HP7, for the reason described below. Specifically, the evaluated fourth titanium plate HP4 to the evaluated seventh titanium plate HP7 each have the weight ratio concentration of the CNTs 204, dispersed and included in the conductive inorganic film 202, within the range between 20 and 50 wt %. Thus, a sufficient conducting path can be ensured due to the contact between the CNTs 204. Furthermore, the inorganic film 202, in which the CNTs 204 are dispersed and included, is conductive in the first place. The evaluated first titanium plate HP1 to the evaluated third titanium plate HP3 each have the weight ratio concentration of the CNTs 204, dispersed and included in the conductive inorganic film 202, within a range between 0 and 10 wt % to be lower than 20 wt %. Thus, the CNTs 204 may fail to be in contact with each other, to result in an insufficient conducting path.

It has been found that the dispersed amount of the CNTs 204 that is equal to or smaller than 10 wt % leads to a large increase in the post-anticorrosion-test resultant resistance value from the initial contact resistance value, which is already quite large. Although not elaborated in the figure, no drop in the initial resistance value or the post-anticorrosion-test resultant resistance value was observed after the dispersion amount of the CNTs 204 has been raised to exceed 50 wt %. All things considered, it has been determined that the separators 150 and 155, used for the unit cell 100, are preferably designed to have the dispersed CNT target concentration of 20 wt % or higher. Furthermore, the dispersed CNT target concentration is preferably within the range between 20 and 50 wt % in terms of resource saving.

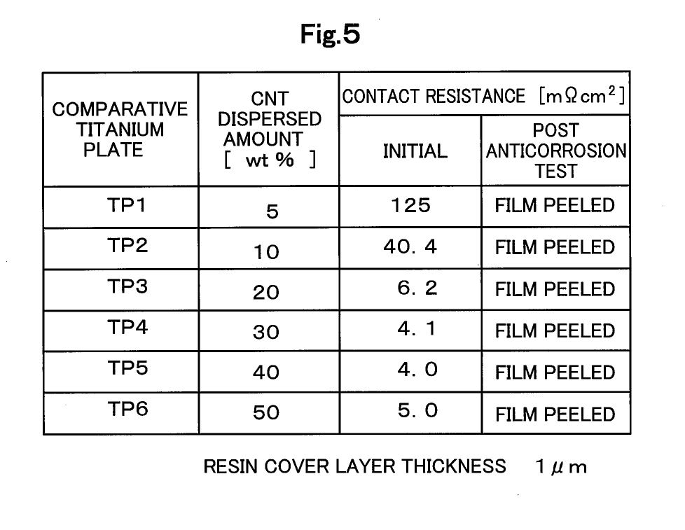

FIG. 5 is a diagram illustrating comparison, in the initial contact resistance value and the anticorrosion test result, among the comparative titanium plates that have the same layer thickness of the resin cover layer but are different from each other in the CNT dispersed amount.

As illustrated in FIG. 5, each of the comparative titanium plates including the resin cover layer instead of the cover layer 200 including the inorganic film 202 has a small initial resistance value when the dispersed amount of the CNTs 204 exceeds 20 wt %. However, the resin cover layer was damaged as a result of the anticorrosion test, and thus the titanium plates were determined to have insufficient anticorrosion performance. This result illustrated in FIG. 5 and the result illustrated in FIG. 4 indicate that the separators 150 and 155 according to the present embodiment having the cover layer 200 with the CNTs 204 dispersed in the inorganic film 202 at a concentration within the range between 20 and 50 wt % can achieve high conductivity with low resistance value ensured and can achieve both sufficient anticorrosion performance and high conductivity under a highly acid environment. The anticorrosion test resulted in a damage on the resin cover layer and resulted in no damage on the evaluated titanium plate because the inorganic film 202 forming the cover layer 200 of the evaluated titanium plate is a crystalline film, meaning that most of gaps in the inorganic film 202 may be smaller than molecules of the corrosive liquid, so that erosion due to the corrosive liquid can be suppressed.

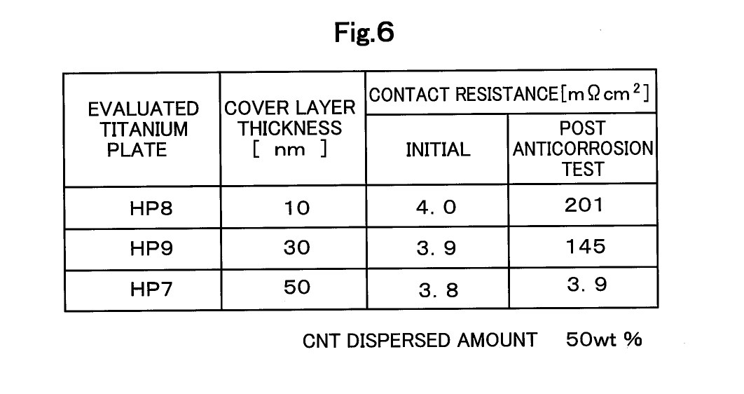

FIG. 6 is a diagram illustrating comparison, in the initial contact resistance value and the post-anticorrosion-test resultant resistance value, among the evaluated titanium plates that have the same CNT dispersed amount but are different from each other in the layer thickness 200t of the cover layer 200.

The result of the comparison in the resistance value illustrated in FIG. 6 indicates that a small initial resistance value can be achieved even when the cover layer 200 including the inorganic film 202 is thin as long as the CNTs 204 are dispersed at a concentration of 50 wt %, and that a large increase in the post-anticorrosion-test resultant resistance value occurs if the layer thickness 200t of the cover layer 200 is smaller than 50 nm. Although not elaborated in the figure, a preferable initial resistance value and a preferable post-anticorrosion-test resultant resistance value are obtained even when the layer thickness 200t of the cover layer 200 exceeds 50 nm as long as the CNT dispersed amount is within the range between 20 and 50 wt %. Thus, the thickness of the cover layer 200 for obtaining the separators 150 and 155 used in the unit cell 100 is preferably set to be 50 nm or larger. Such a thickness can more effectively ensure sufficient anticorrosion performance. With the thickness of the cover layer 200 set to be 500 nm or smaller and the CNT dispersed amount set to be within the range between 20 and 50 wt %, the used amount of the CNT 204, which is expensive, can be limited, whereby a material cost can be reduced.

The present disclosure is not limited to the embodiment and a modification described above but may be implemented by a diversity of other configurations without departing from the scope of the present disclosure. For example, the technical features of any of the above embodiment and its modification corresponding to the technical features of each of the aspects described in Summary may be replaced or combined appropriately, in order to solve part or all of the problems described above or in order to achieve part or all of the advantageous effects described above. Any of the technical features may be omitted appropriately unless the technical feature is described as essential in the description hereof.

In the embodiment described above, the CNTs 204 are dispersed in the inorganic film 202 forming the cover layer 200. Alternatively, another carbon-based conductive material may be dispersed in the inorganic film 202. Examples of the other carbon-based conductive material include carbon nanofibers, carbon nanohorns, and carbon particles.

In the embodiment described above, the inorganic film 202 is made of a conductive inorganic material including ITO and ATO. Alternatively, a thin film including other conductive inorganic material may be employed.

In the embodiment described above, the inorganic film 202 is formed over the entire front and back surfaces of the separators 150 and 155. Alternatively, the inorganic film 202 may be formed partially on the front and the back surfaces of the separator as long as the conducting function can be provided. The metal base material is not limited to titanium used in the embodiment, and may employ various types of metal including titanium alloy, tungsten or stainless steel.

In the embodiment described above, the cover layers 200 including the inorganic film 202 are formed on the separators 150 and 155. Alternatively, the cover layers 200 may be formed on cell contact surfaces of the terminal plates 160E and 160F in contact with the unit cells 100 at both ends of the fuel cell stack 105.

In the embodiment described above, the oxygen flow path 151 is formed by the separator 150, the hydrogen flow path 156 is formed by the separator 155, and the coolant flow path 152 is formed by the separators 150 and 155 of the adjacent unit cells 100. However, the present invention is not limited to the configuration of forming the gas/coolant flow paths with the separators as described above. For example, a flow path plate forming the anode side gas flow path and a flow path plate forming the cathode side gas flow path may be prepared separately from the separators. Thus, the coolant flow path may be formed with the separator branching the flow of gas toward the anode side and the cathode side. With this configuration, the power generation cell has the conducting function on the anode side and the cathode side flow path plates. Thus, the anode side and the cathode side flow path plate may each be formed with the cover layers 200 provided on the front and the back surfaces of the metal base material, as illustrated in FIG. 3. The separators may have the cover layers 200 provided entirely over the metal base material surface on the side to be in contact with the anode side flow path plate, entirely over the metal base material surface on the side to be in contact with the cathode side flow path plate, and entirely over the metal base material surface on the side where the separators come into contact with each other. Note that the metallic conducting function member may have the cover layer 200 provided only on the separator or only on the flow path plate.

What is claimed is:

1. A metallic conducting function member used for conducting electricity in a fuel cell stack, the metallic conducting function member comprising:
a conductive metal base material; and
an inorganic film that at least partially covers a surface of the metal base material, wherein
the inorganic film is a thin film made of a conductive inorganic material, and includes a carbon-based conductive material dispersed at a weight ratio concentration that is equal to or higher than 20%.

2. The metallic conducting function member according to claim 1,
wherein the inorganic film covering the surface of the metal base material has a thickness that is equal to or larger than 50 nm.

3. The metallic conducting function member according to claim 1,
wherein the inorganic film is a crystalline thin film made of the inorganic material.

4. The metallic conducting function member according to claim 1,
wherein the weight ratio of the carbon-based conductive material in the inorganic film is equal to or lower than 50%.

5. The metallic conducting function member according to claim 1,
wherein the inorganic film covering the surface of the metal base material has a thickness that is equal to or smaller than 500 nm.

6. The metallic conducting function member according to claim 3,
wherein the inorganic film covering the surface of the metal base material has a thickness that is equal to or smaller than 500 nm.

7. The metallic conducting function member according to claim 2,
wherein the weight ratio of the carbon-based conductive material in the inorganic film is equal to or lower than 50%.

8. The metallic conducting function member according to claim 7,
wherein the inorganic film covering the surface of the metal base material has a thickness that is equal to or smaller than 500 nm.

9. The metallic conducting function member according to claim 2,
wherein the inorganic film covering the surface of the metal base material has a thickness that is equal to or smaller than 500 nm.

10. The metallic conducting function member according to claim 1,
wherein the inorganic film is a crystalline thin film made of the inorganic material.

11. The metallic conducting function member according to claim 10,
wherein the weight ratio of the carbon-based conductive material in the inorganic film is equal to or lower than 50%.

12. The metallic conducting function member according to claim 11,
wherein the inorganic film covering the surface of the metal base material has a thickness that is equal to or smaller than 500 nm.

13. The metallic conducting function member according to claim 10,
wherein the inorganic film covering the surface of the metal base material has a thickness that is equal to or smaller than 500 nm.

14. The metallic conducting function member according to claim 1,
wherein the weight ratio of the carbon-based conductive material in the inorganic film is equal to or lower than 50%.

15. The metallic conducting function member according to claim 14,
wherein the inorganic film covering the surface of the metal base material has a thickness that is equal to or smaller than 500 nm.

16. The metallic conducting function member according to claim 1,
wherein the inorganic film covering the surface of the metal base material has a thickness that is equal to or smaller than 500 nm.
